(19) United States
(12) Patent Application Publication
(10) Pub. No.: US 2007/0295591 A1
(43) Pub. Date: Dec. 27, 2007

(54) Distillaion column

(76) Inventor: Jurgen Mosler, CASTROP-RAUXEL (DE)

Correspondence Address: SMITH MOORE LLP, P.O. BOX 21927, GREENSBORO, NC, 27420, US

(21) Appl. No.: 11/547,110

(22) PCT Filed: Mar. 29, 2005
(86) PCT No.: PCT/EP05/03272

§ 371 Date: Jul. 13, 2007

(30) Foreign Application Priority Data
Mar. 29, 2004 (DE) 10 2004 015 727.8

(51) Int. Cl. B01D 3/14

(52) U.S. Cl. 202/158

(57) ABSTRACT

Column (1) for distillation of a polymerizable material, whereby the column (1) comprises a container (2) with a lower floor (8), as well as at least one inlet (4) for the polymerizable material, which leads into an inner region (5) of the column (1), characterized in that means for uniform distribution of the material in the container (2) are provided.

This application is a national stage application under 35 U.S.C. 371 of international application No. PCT/EP2005/003272 filed Mar. 29, 2005, and claiming priority to German Application No. DE 10 2004 015 727.8 filed Mar. 29, 2004, the disclosures of which are expressly incorporated herein by reference.

The invention relates to a column for distillation of a polymerizable material, in particular methacrylic acid and acrylic acid, referred to in the following together as “(meth)acrylic acid,” whereby acrylic acid is the polymerizable material in one aspect.

The standards of purity of monomers used on a large scale for polymerization are ever increasing. Ever higher purity standards are also demanded of mass plastics. This is particularly the case for polymers used in the areas of medicine or hygiene. Water or aqueous liquids-absorbing polymers, which are generally referred to as “superabsorbers,” are an important component of many products in medical and hygiene areas. Superabsorbers are used in diapers, feminine hygiene products and incontinence articles. Superabsorbers, as well as other artificial materials, are often obtained by radical polymerization of monomers comprising a double bond. Such monomers comprising a double bond, such as (meth)acrylic acid are, thus, very reactive substances, which tend to radically polymerize spontaneously under thermal stress.

Distillation is a suitable processing method which has been proven on a large scale for obtaining high purities. Because of the thermal stress on the monomer to be purified which occurs during distillation, the monomer tends, however, to undergo undesired polymerization. Here, despite addition of inhibitors, polymerization seeds form, initially mostly in dead zones through overheating and too long residence times of the monomer, which seeds grow in the course of time and lead to an ever increasing formation of undesired polymer, which leads to a shutting down of the distillation operation and to a time-consuming cleaning of the distillation apparatus, which is very costly and linked with a significant strain for man and the environment.

Distillation columns are, for example, known from WO 00/53561. In this document “Dual-Flow-Trays” are disclosed as column trays, with which the separation performance should be increased, but no measures are disclosed with which the above disadvantages should be counteracted.

Starting from this point, one aspect of the present invention reduces the known technical problems in distillation or overcomes them.

In particular, an aspect of the invention is to further develop known columns such that the tendency to polymerize of the material to be distilled is clearly reduced.

In another aspect of the invention, a column is provided which can be operated continuously over a longer time period.

In addition, the optionally necessary maintenance and/or cleaning processes should become easier to carry out and take less time.

In yet a further aspect of invention, a distillation column is made available, and a distillation process which manages with as few column trays as possible, in particular Dual-Flow-Trays, with, if possible, no impairment of the separation performance.

The column of the present invention comprises a container with a lower floor as well as at least one inlet for the polymerizable material, which leads into the inner region of the container. According to the invention, means for uniform distribution of the material in the container are provided. The means can be in or at the inlet as integral or separate component. Further, means of this type can also be provided in the inner region of the container. In addition, it can make sense under certain circumstances that the container comprises, as integral or separate component, means for uniform distribution of the material in the container. Because of the fact that the polymerizable material flows predominantly in liquid state, in particular as superheated liquid, via the inlet into the inner region of the container, the means are particularly suited to influencing the flow behavior of the introduced, liquid material. In one aspect, directly after entry into the container of the column, the liquid material at least partially evaporates, whereby finally a vapor or gaseous state flow rising upwards is formed. With a uniform distribution is particularly meant that the polymerizable material, already after a short time (in at least its initial liquid or its subsequent gaseous state) flows through the inner region, with a uniform flow rate above the cross-section of the inner region of the container of the column. This is particularly the case in a cross-section parallel to a first separating tray in the immediate proximity thereof (e.g. at a separation of less than about 10 cm). This has the result that the tendency to polymerize is reduced, so that fewer agglomerates formed through polymerization collect in or at the column and components thereof, and the efficient operation is assured.

A uniform flow of the polymerizable material can be described by a number of different parameters known to the skilled person. Thus, for example, the material speeds, the distribution of the flow direction or other parameters can be used. The distillation is, in addition, characterized by flows of liquid and gaseous components of the polymerizable material which are substantially directed opposed to each other: The liquid flows, as a result of gravity, downwards through the separating trays, while the gas flow flows upwards through the separating trays within the column. If substantially the same flow ratios prevail in a cross-section or a level of the container of the column, the liquid and the gaseous components of the polymerizable material are also uniformly distributed in this level. This is not only the case for the region of the container which can be flowed through freely, but also, for example, within the separating trays. It can also be seen there, by means of the distribution of gaseous, liquid and solid components of the polymerizable material, whether a uniform flow is present, i.e. for example, no accumulations of agglomerates formed by polymerization are present.

According to a further aspect of the column, the at least one inlet has an entry orifice and an exit orifice, whereby the exit orifice is arranged closer to the lower floor of the column than is the entry orifice. It should be mentioned in this context, that the inlet itself can be an integral part of the container, i.e. the limiting surface of the inlet is itself part of the container. The inlet can, however, also be a separate component, which is connected to the container, for example, by means of a connector. In the last mentioned case, the inlet accordingly extends through a connector orifice of the connector into the inner region of the container. In this aspect, sealants are provided which prevent a gas exchange from the inner region of the container to the outer surroundings of the container. Because of the fact that columns of this type are generally standing vertically, and it is proposed according to the invention that the exit orifice is positioned closer to the lower floor of the container than is the entry opening, it should, in particular, be brought about that the material flows into the inner region of the container of the column in a direction which is different to the direct flow direction during the distillation process towards the outlet of the product (in particular against the direction of gravity). With the thus forced change of direction, a turbulence and/or an equilibration of concentration differences of the material in the cross-section of the inner portion is achieved. In this context, it is particularly advantageous that the at least one inlet has an exit orifice, which is arranged substantially parallel to the lower flow. By this is particularly meant that the polymerizable material is introduced into the inner region of the container of the column in a direction which is substantially opposed to the direct flow direction. It can be seen therefrom that the polymerizable material flows into the inner region substantially perpendicular to the exit orifice. A parallel arrangement of the exit orifice towards the lower floor has the additional advantage that, with a sufficiently high flow rate of the material flowing in, the lower floor functions as a sort of deflector. This means that the impinging material is swirled, whereby the lower flow may be designed such that, in turn, dead zones, in which the gaseous material becomes liquid and a part of the liquid remains for so long that it can partially solidify by polymerization, are avoided. In this aspect, the exit orifice of the inlet is positioned central to a central axis of the container, in order to ensure a uniform distribution of the material flowing in. If more than one inlet is provided, these are arranged symmetrically to the central axis in one aspect, in particular within a cross-section level parallel to the lower floor or to the separating tray.

According to an advantageous further development of the column, it is proposed that the at least one inlet has an exit orifice, whereby via a section of the at least one inlet, such as at least close to the exit orifice, at least one flow influencer is arranged. Flow influencers of this type can, on the one hand, be arranged on the outer side of the inlet, i.e. in the inner region of the container of the column. It is, however possible, on the other hand, in combination or alternatively, to position flow influencers of this type on the inside of the inlet. Flow influencers of this type on the inside of the inlet have, in particular, the function of adapting the flow behavior of the polymerizable material upon entry into the inner region, to the ambient conditions prevailing in the inner region of the column.

It is, thus, for example, possible that flow influencers of this type already cause a certain turbulence of the material, whereby this then comes into consideration, in particular if the container itself does not contribute directly to making the material flowing in uniform. If such a flow influencer serves primarily to swirl the material inside the inlet, the flow influencer generally extends over a relatively short section, in particular over a section in a range from about 2 mm to about 100 mm, in another aspect from about 10 mm to about 50 mm, and in yet a further aspect from about 15 mm to about 35 mm, whereby this may be arranged in a bent region of the inlet and such a turbulence on the inside of the inlet causes the liquid material entering into the inner region to change quickly and to a large proportion into the gaseous aggregate state. A uniform flow towards the separating trays can be achieved, for example, by means of additional means.

Particularly suited for this are temperature- and corrosion-resistant, optionally fiber-type materials, which are arranged chaotically, irregularly, in disordered position to each other, as woven material or in a similar way to each other. In one aspect, they comprise a plurality of tear-off edges or surfaces to flow against or both, which result in a turbulence of the polymerizable material. On the other hand, it is, however, also possible that such a flow influencer has the function of generating a close to laminar flow, in particular upon entry into the inner region of the column.

In one embodiment of the invention, the at least one flow influencer comprises at least one baffle, so that a plurality of channels is formed over the section of the inlet. With such an embodiment of the flow influencer, this flow influencer is in one aspect present on the inside of the inlet over a section in a range from about 100 mm to about 2000 mm, in another aspect from about 400 mm to about 1500 mm, and in yet a further aspect from about 700 mm to about 1000 mm. The plural baffles may be arranged one after another in the flow direction of the material, whereby these baffles in principal extend totally at least in the region, and in one aspect over the whole section of the region of the bending section of the inlet. With respect to the flow influencer, it is also possible that this also extends into the inner region of the container, so that in one aspect a projection in the range from about 50 mm to about 200 mm is formed.

The division of the inlet into a plurality of channels has the advantage that partial flows are formed, whereby with increasingly smaller channel cross-sections, a directed, optionally close to laminar flows form in the channels, already after short distances. The number of such channels is inter alia to be selected taking into account the design of the container or of the inner space thereof. This means that for the case that outside the inlet sufficient means for uniform distribution of the material are provided, as targeted as possible a flowing in towards these means can be adjusted. In one aspect, small channel cross sections or a large number of channels are used. To this end, individual baffles, baffles connected to each other, structured baffles, or similar construction can be used, whereby these can also be formed as a type of honeycomb structure, under some circumstances. The principal of the honeycomb structure means, in particular, a plurality of separated channels, which are arranged substantially parallel to each other, whereby optionally through holes can also be provided in the baffles, so that channels are formed which communicate with each other. In this aspect, the channel density as number of channels/unit cross-section area in the inlet is not more than about 5 channels/cm², in another aspect not more than about 3 channels/cm², in yet another aspect not more than about 1 channel/cm², and in yet an additional aspect not more than about 0.5 channels/cm² or even less than about 0.25 channels/cm².

In principal, the division of the flowing in, liquid material is also advantageous since in this way a more complete release of pressure or respectively a more complete conversion into the vapor or gaseous state is achieved, if the material is exposed to an absolute pressure in a range from about 50 to about 400 hPa, in another aspect from about 100 to about 300 hPa, and in yet another aspect from about 150 to about 250 hPa in the inner region of the column (whereby 1 hPa=1 mbar=10² Newton/Meter² [N/m²]=10² Pa). A similar effect is achieved by means of an inlet which has, as flow influencer, at its exit side a plurality of nozzles or pipe openings (e.g. in the range from about 10 to about 30, and in another aspect from about 12 to about 25), which may be arranged symmetrically, in particular with the same separation, to the central axis of the inlet.

In a further embodiment of the column with at least one inlet, which has an exit orifice, at least one flow distributor is arranged in the inner region of the container, in particular central to a central axis of the exit orifice. The case mentioned, in which the at least one flow distributor is positioned perpendicular to the central axis of the exit orifice is particularly true if the polymerizable material also flows out of the inlet substantially parallel to the central axis of the exit orifice. For the case that, for example, by using the above-mentioned baffles a direction of the material deviating hereof is generated, it can be advantageous to arrange the at least one flow distributor central to this flowing out direction. The flow distributor has, in particular, the function of distributing quickly and evenly in the inner region of the container of the column, the spatially rather tightly restricted flow which exits from the inlet. Thus, the flow distributor can, for example, in turn be formed as deflector surface, it is, however, also possible that the flow distributor can be at least partially flowed through by the flowing material. In the last-mentioned case, the use of sieves, gratings or similar structures would, for example, be possible. This has the advantages that, viewed in the flow direction of the material flowing in, a part of the polymerizable material passes behind the flow distributor and accordingly a uniform distribution is quickly achieved.

When designing such a flow distributor, it is particularly advantageous that the at least one flow distributor is designed at least partially tapered, in one aspect at least to about 30%, in another aspect at least to about 70% of the central axis, and yet in another aspect completely conical, whereby a tip, or, with a blunt conical form the region with the smallest radius of the flow distributor is arranged on the central axis of the exit orifice such that the tip of the exit orifice is closest. It is first mentioned that not necessarily or exclusively a sharp-edged projection is meant by tip, rather, slightly rounded tips should also be included here. It is, here, again assumed that the polymerizable material flows out perpendicular to the exit orifice of the inlet, the tip is thus in central position with respect to the material flowing out. It is again here true that it can be advantageous to position the conical flow distributor with its tip adjacent the central axis, if the material does not flow perpendicularly to the exit orifice from the inlet. With reference to the conical design of the flow distributor, it should further be mentioned that the flow distributor can be formed both as hollow profile (hereunder should be understood, in particular, a conical profile which is not closed, whereby, in one aspect, plates, webbing or similar, in particular thin-walled, optionally perforated, materials are used in the design) or as solid body (i.e. either a closed profile made from thin materials or a body without hollow spaces). This conical design of the flow distributor has the advantage that, with the central flowing towards of the material, the material is fanned out uniformly from the tip via the jacket surfaces of the cone in all radial directions. In this way, a relatively gentle deflection occurs, so that undesirable strong turbulence is avoided.

According to a further development of the column, the container comprises at least one guiding surface. The guiding surface can in turn be an integral component of the container itself, it is, however, also possible, that it is a separate component, which is, for example, connected to the container by means of technical joining manufacturing processes. This guiding surface also has the function of effecting a particular flow profile or a targeted deflection of material partial flows for uniform distribution of the inflowing, polymerizable material. It is particularly advantageous if the inflowing polymerizable material is distributed uniformly in the inner region of the column by using at least two of the following means. By means of the inlet itself, by means of at least one flow influencer of the inlet, by means of at leans one flow distributor or at least one guiding surface of the container. In this context, it should be noted that the position of the flow edges or surfaces respectively with respect to the container walls is suitable as differentiation criterion between the flow distributor, which can also be connected to the column in some way and the guiding surface of the container. Thus, the guiding surface of the container is directly adjacent to the container or the guiding surface is itself part of the inner wall of the container. With the flow distributor, for example, the conical jacket surface is at a distance from the inner wall of the container, whereby special fittings are provided which connect the flow distributor with, for example, the inner wall of the container or also with the inlet itself.

According to a further embodiment of the column, it is proposed that the at least one inlet comprises means for thermal insulation from the inner region. Generally, such distillation columns are equipped with enforced circulation overheaters, whereby the polymerizable, liquid material is superheated and than conducted in vapor or gaseous state via the inlet into the inner region of the container of the column. Because of this, the inlet generally has a significantly higher temperature compared to the inner region of the container. This temperature difference can lead, for example, to liquid, drop like accumulations of the polymerizable material collecting on the surface of the inlet, whereby this can result in formation of viscous, substantially stationary clumpings.

In this context, it is proposed that the means for thermal insulation are arranged on at least one partial area of the inlet, which extends into the inner region of the container of the column. In one aspect, the means for thermal insulation do not extend over or in the whole inlet, but rather that only partial areas suited for accumulation can be provided with such thermal insulation means. In this context, the partial areas or positions of the inlet comprised the recesses, columns, capillaries, material borders or the like. These partial areas are particularly suited to serving as reservoir for gaseous or liquid polymerizable materials. Since the regions can occur, for example, at the exit of the inlet from the container, it can be advantageous also to provide the inlet with thermal insulations beyond the inner region of the container.

According to further embodiment, it is proposed that the means for thermal insulation through an inlet are formed from at least partially thermally insulating material. This means, for example, that the inlet itself is formed with a thermally insulating material. It is, however, also possible to provide the inlet with a thermally insulating coating or sheath, with respect to the inner region of the column. By coating is understood that the thermally insulating material is applied in one aspect using joining technology onto the surface of the inlet (in particular, the two materials form a common border layer with each other) while with sheaths a clearly limitable component which can in one aspect be applied removably at or in the inlet is understood.

In this context, it should be noted that the number or the strength of the thermally insulated material surrounding the inlet should be selected substantially from the temperature difference between the superheated inflowing material and the inner region of column, in particular in the range from about 1° C. to about 30° C., in another aspect from about 5° C. to about 25° C., and in yet another aspect from about 8° C. to about 15° C.

According to a further embodiment of the invention, it is proposed that the at least one inlet has more than one jacket, whereby, in one aspect, a thermally insulating layer is provided between at least two jackets. The jackets, which are arranged in particular co-axial to each other, form a type of border layer, independent of whether they are at a distance from each other or in contact with each other. This border layer has the result that a heat transfer from the inner-lying sheath to the outer sheath or vice versa is hindered. This effect is further strengthened if, between the jackets, an additional, thermally insulating layer of a material with low heat conductivity, for example, is arranged. For this, for example, inorganic expanding mats or similar components can be used, which can optionally also compensate thermal differential expansion of the components of the inlet.

In an embodiment of the inlet with more than one jacket, in one aspect, the thermally insulating layer provided between the jackets is a vacuum, whereby at least one inner surface of the more than one jacket may be mirrored. By means of the vacuum between, for example, two jackets arranged co-axial to each other (double-walled jacket pipe), the heat transfer from one jacket to the other by means of convection is eliminated. For prevention of heat radiation, at least one of the inner surfaces of the jackets is mirrored.

According to a further embodiment of the column, the at least one inlet comprises, at least in a partial section, a coating, which comprises an improved glide property for liquids, compared to steel. In this aspect, the total surface up to the inner region of the column is provided with such a coating. Examples of coatings or coating materials include a polyfluorohydrocarbon, such as Teflon®, polyaniline varnishes or coatings with a metal ion-free surface (e.g. glass) or also mixtures of at least two of these types of coating. If glass is used as coating agent, it can be technical glass, which has been obtained from cooled melts of silicon dioxide (SiO₂), calcium oxide (CaO), sodium oxide (Na₂O), optionally with larger amounts of boron trioxide (B₂O₃), aluminium oxide (Al₂O₃), lead oxide (PbO), magnesium oxide (MgO), barium oxide (BaO) or potassium oxide (K₂O). This technical glass may consists to at least about 50 wt. %, in another aspect to at least about 65 wt. %, and in yet another aspect to at least about 80 wt. % of SiO₂. The coating has the effect that accumulations or deposits of liquids or viscous or solid polymerizable materials on the inlet is reduced. It is, then, generally advantageous also to provide other regions of the column or of the container or of other components in the inner space of the column with such a coating. More details concerning the property or embodiments of the surfaces or coating can be taken from the description for FIG. 9.

According to a further development of the column, the at least one inlet is arranged between the lower floor and a separating tray. That means, in particular, that by means of the lower floor, a deflection of the inflowing polymerizable material is effected and this material passes the region of the inlet again, before it passes through the separating tray for the first time.

It is further also proposed that the container comprises a plurality of separating trays and at least one spraying unit is provided, with which a lower side of at least one separating tray can be sprayed with the polymerizable material. A spraying unit of this type effectively removes partial amounts of the polymerizable material adhering to the lower side of the separating tray, so that a polymerization at this position can be avoided. In one aspect, the lowest separating tray of the column is positioned within reach of such a spraying unit. It is here advantageous that the spraying unit is supplied with liquid polymerizable material from the collecting reservoir of the container, and this material is sprayed uniformly distributed from the lower side of the separating tray. In one aspect, the spraying unit comprises a plurality of nozzles, which form evenly distributed spray areas over the cross-section of the separating tray. In another aspect, the spraying unit is operated with high pressure, e.g. in a range from about 2 to about 5 bar, such as at about 3 bar. In another aspect, the spraying unit is positioned at a short distance from the lower side of the separating tray, for example, at most about 1 meter or about 50 cm, whereby this can be varied taking into account the spray area and/or the number of nozzles.

The invention further relates to a process for purification of a polymerizable material, whereby the polymerizable material in the column according to the invention is introduced as a liquid through the inlet and in the inner region is transferred to an at least partially vapor or gaseous state. In this aspect, the vapor or gaseous state flows with a isotropic density against a first separating tray arranged above the inlet, whereby within a level between the inlet and the first separating tray the maximum deviation from an average volume of the isotropic density is at most about 15%. It is particularly advantageous if the maximum deviation is at most about 10%, such as only about 5%. In one aspect, the level here lies relatively tight and parallel to the first separating tray, in order to ensure a relatively compact construction of the column. In this aspect, the level lies at most about 100 mm below the first separating tray, the distance of the level from the first separating tray can, however, also be at most about 50 mm or even only at most about 10 mm.

A particularly even distillation with a very low tendency to polymerize in the column is given if the at least one separating tray is designed such that the isotropic density is also reached in the liquid material of the polymerizable material. It can be achieved particularly by the use of a so-called “Dual-Flow-Tray.” In this way, any optional flow of the vapor or gaseous state over the separating tray can be implemented with the proposed isotropic density, whereby the maximum deviation occurring is further clearly reduced.

Such a separating tray for a column for distillation of a polymerizable material comprises at least one tray plate with a plurality of openings and at least one attachment which divides the plurality of openings into groups, whereby with the at least one attachment, apertures which can be flowed through by a liquid are formed.

In one aspect, the tray plate comprises metallic material, although other temperature- and acid-resistant material can also be used. The outer design of the tray plate is to be selected with respect to the distillation column, so that this can comprise, for example, round, square or similar forms. The tray plate is provided with a plurality of openings, whereby it is, in particular, intended that a liquid and/or gas exchange through the tray plate is possible.

The openings may be, thus, so large that it is possible to retain the liquid material, and in one aspect, a bubbling layer for heat and component exchange forms between the liquid and vapor or gaseous state material. The arrangement of the openings with respect to the tray plate can, in principal, be freely selected and should be aligned with the conditions on the inside of the column. It is thus, for example, possible to provide a uniform distribution of the openings over the whole tray plate, on the other hand, it can also be necessary to take a design of the tray plate which deviates herefrom. This would be, for example, the case, if edge regions of the tray plate were necessary for positioning in the column. A similar case is, for example, if the tray plate must be supported on one side because of its spatial extension and the supports would close openings of this type. It is then advantageous to provide no openings in these regions of the tray plate.

It is now proposed that the attachment divides the plurality of openings into groups, whereby with the at least one attachment, apertures are formed which can be flowed through by a liquid. A foreground function of this attachment is to influence the movement of the liquid, which has collected on the tray plate, so that, on the one hand, a high flow speed is avoided, and on the other hand, however, that no “dead zones” are formed in which relatively long resistance times of the liquids prevail.

Particularly high flow speeds can, for example, occur if the gaseous material passing through the tray plate is not introduced completely uniformly over the cross-section of the tray plate, but, rather, in one region a particularly strong source is formed. A wave like stimulus to the liquid can then occur. In order to prevent a wave front of this type spreading over the whole tray plate and thus leading to different liquid levels on the tray plate, the attachment serves as a type of wave breaker, in that it is capable of calming waves in the upper liquid or vapor bubble layers.

Indeed, the spatially strictly delimited division of the tray plates from each other into different sectors does not necessarily guarantee an improved behavior of the liquid. Rather, by means of the division, groups of openings can be formed, which are less impinged on by the polymerizable material, so that, with respect to the sectors, different degrees of distillation can occur. For this reason, it is proposed that the liquid is indeed restricted in its freedom of movement by the attachment, but is not restricted with respect to the reachability of a plurality of openings of other sectors (in particular of all openings). This is achieved in that with the attachment, apertures which can be flowed through by a liquid are still formed. In one aspect, the apertures ensure that the liquid can flow towards any opening of the tray plate.

The design of the aperture should also be selected here taking into account the liquid, the polymerizable material, the column or its operation. By way of example, round apertures, square apertures, slots, etc. are mentioned here. It should also be clarified that the apertures can be fully or partially limited and/or formed by the attachment. In principal, it is advantageous in the arrangement of such apertures, to arrange these in lower regions, i.e. near to the tray plate. In this way it is ensured that, on the one hand, the propagation of the wave movement of the upper liquid or fluid layers is interrupted, while deeper-lying layers near to different groups of openings can communicate with each other. Attention should be paid that the apertures are designed so that as few as possible, such as no, dead zones are formed, whereby in this context, zones are meant in which the liquid has a relatively long residence time.

The liquid tends to polymerize in dead zones of this type, whereby this can lead in the long term to at least partial blocking of the openings. This has the result that the gas or liquid exchange then only occurs through a smaller number of openings, whereby the increasing gas pressure results in an additional wave stimulus of the liquid. With increasing polymerization of material, the distillation step can no longer be carried out in the desired quality, making purification and/or maintenance measures necessary. This in turn has the result that the distillation process must be interrupted and the column shut down. The separating trays must be further cleaned in a time-consuming process and then remounted. By means of the herein-proposed attachment on the tray plate, such complex measures can at least be deferred over a longer time period. Because of the fact that polymer deposits occur at significantly fewer positions, the purification can also be carried out more quickly. This means that the distillation column, on the one hand, is ready for operation over a longer time period with the desired distillation results, on the other hand, however, the purification procedure can be carried out more quickly and, thus, the down times of the distillation column are shortened.

In general, as polymerizable material, according to the invention, all chemical compounds which tend to polymerize and are known to the skilled person come into consideration. Polymerizable materials can be monomers used in the production of mass plastics, such as, styrene, α-methyl styrene, methylmethacrylate, butylacrylate and the like. The polymerizable material used in the process according to the invention also can be (meth)acrylic acid. The term “(meth)acrylic acid” here stands both for the compound with the nomenclature name “acrylic acid” and for the compound with the nomenclature name “methacrylic acid,” whereby of the two, acrylic acid is the polymerizable material in one aspect of the present invention. In one embodiment of the process according to the invention, in the inner region an absolute pressure prevails. This pressure lies in the range from about 50 to about 400 hPa (hectopascal) in one aspect, from about 100 to about 300 hPa in another aspect, and from about 150 to about 250 hPa in yet another aspect in the inner region of the column (whereby 1 hPa=1 mbar=10² Newton/meter² [N/m²]=10² Pa).

In another aspect of the process according to the invention, the liquid is superheated. In this aspect, the temperature of the main component of the liquid, mostly the polymerizable material, may lie at least about 1° C., in another aspect at least about 5° C., and in yet another aspect at least about 10° C. above the boiling temperature of the pure head component of the liquid.

The invention further relates to a process for production of a polymerizable material, whereby the polymerizable material is synthesized from at least one reagent in a reactor and then subjected to a process according to the invention for purification. The synthesis of the polymerizable material is not limited to a particular process. Rather, all processes known to the skilled person can be considered. In the synthesis of acrylic acid, in one aspect an at least two-step gas phase oxidation reaction, in which in a first step, by catalytic oxidation of propylene, acrolein is obtained and in a further step, acrylic acid is obtained as gas phase. This gas phase is then brought into contact, in a quench unit, with a liquid, such as water or an organic compound which boils higher than water or a mixture thereof and indirectly or directly subjected to the process according to the invention for purification. Details concerning the production and further purification processes for acrylic acid can be taken from WO 02/055469 and the reference cited therein.

In addition, the invention relates to the use of an inlet according to the invention for distillation of a polymerizable material.

Furthermore, the invention relates to a polymerizable material obtainable according to a process according to the invention.

In addition, the invention relates to the use of a polymerizable material according to the invention as starting material in formed masses, fibers, sheets, absorbent polymers, in polymers for leather and textile processing, in polymers for water treatment or in polymers for soap production.

The invention also relates to formed masses, fibers, sheets, absorbent polymers, polymers for leather and textile processing, polymers for water treatment or polymers for soap production, at least partially based on a polymerizable material according to the invention.

The invention is now more closely illustrated by means of the figures, whereby the example embodiments depicted show embodiments of the invention or of the incorporation of the invention into the known field of distillation columns illustrated. It should be mentioned that the invention is not restricted to the depicted example embodiments. In addition, independent thereof, further particulars are also described concerning the technical area of distillation columns.

### THE FIGURES SHOW

FIG. 1 shows schematically and in perspective, the construction of a column with an inlet for a polymerizable material;

FIG. 2 shows schematically, a sectional view through a design of a separating tray;

FIG. 3 shows a schematic view of a further embodiment of a separating tray;

FIG. 4 shows a further schematic view of a further embodiment of the separating tray in section;

FIG. 5 shows a simplified schematic representation of different embodiments of a flow rectifier;

FIG. 6 shows a schematic detailed view of an embodiment of a coated tray plate of a separating tray;

FIG. 7 shows a schematic representation of an installation for production of acrylic acid;

FIG. 8 shows schematically, the construction of a trial arrangement for determination of the density distribution;

FIG. 9 shows schematically and in perspective, a waved tray plate of a separating tray;

FIG. 10 shows schematically and in perspective, a further embodiment of the inlet with a flow mixer;

FIG. 11 shows a partial section of a container with a spray unit in cross-section; and

FIG. 12 the top view of the spray unit shown in FIG. 11.

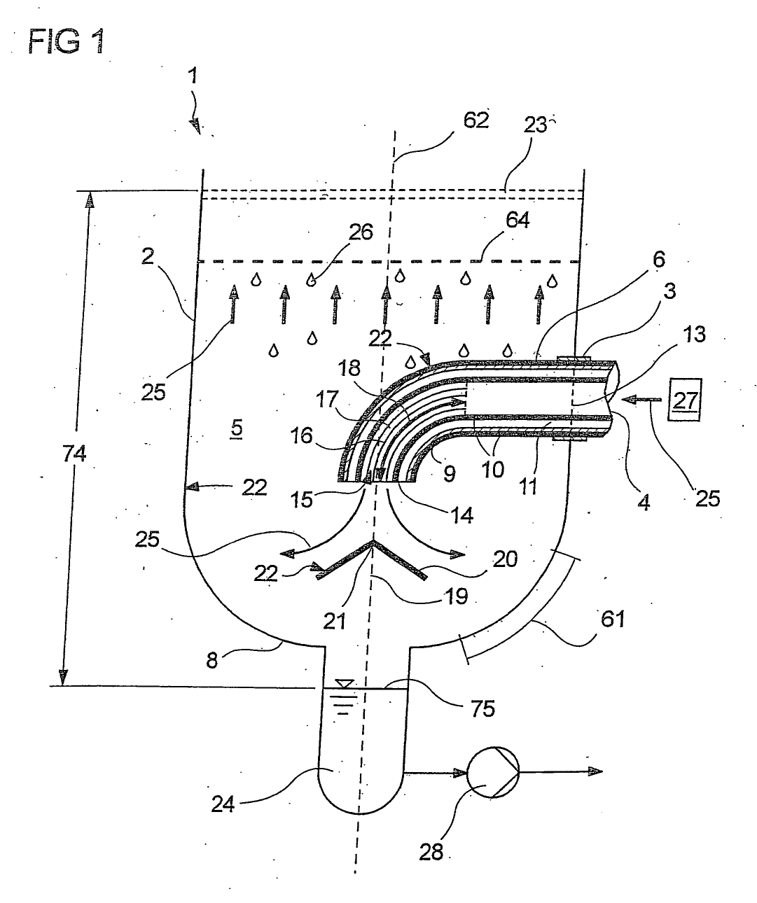

FIG. 1 shows schematically and in a section view a column 1 for distillation of polymerizable material, whereby this comprises a container 2 with a lower floor 8 as an inlet 4 for the polymerizable material. The inlet 4 leads into an inner region 5 of the container 2. As more closely detailed in the following, column 1 comprises various means for uniform distribution of the material in the container 2.

In order to be able, in principal, to understand the flow course of the polymerizable material, its path through column 1 is first described. Generally, the polymerizable material is initially present as liquid and is transformed and/or superheated into a vapor and/or gaseous state by means of a heater 27. Starting from heater 27, the material flows in flow direction 25 through an inlet 4 into the inner region 5 of the container 2. At entry, or a short time after entry into the inner region 5, the partially liquid, partially vapor or gaseous material flows further in flow direction 25 (here depicted vertically upwards by means of the arrows) towards a separating tray 23, in which a first distillation stage is carried out. Condensed components of the material in the form of drops fall back in the direction opposed to flow direction 25 onto the inlet 4 or onto the lower floor 8 of container 2. At the lowest position, container 2 comprises a collecting reservoir 24, in which the condensation collects. This collecting reservoir is connected to a pump 28, which effects the transport away of the condensation in the collecting reservoir 24 from column 1.

Upon closer observation of inlet 4, it can first be seen that this has an entry orifice 13 and an exit orifice 14, whereby, here, the exit orifice 14 is arranged closer and substantially parallel to the lower floor 8 of container 2. The inlet 4 is depicted as separate component, which extends through an attachment 3 through container 2 into the inner region 5. The inlet 4 comprises straight and bent partial regions, whereby these are here designed so that the exit orifice 14 is positioned with its central axis 19 central to the central axis 62 of container 2. On the inside of the inlet 4, a flow influencer 15 is arranged over a section 18 towards the exit orifice 14. The flow influencer 15 comprises a plurality of baffles 16, which ensure channels 17 for equilibration of the flow of the polymerizable material on the inside of the inlet 4. Central to the central axis 19 or to the central axis 62, a conical flow distributor 20 is arranged such that its tip 21 is closest to the exit orifice 14. As depicted in FIG. 1 by means of the arrow (flow direction 25), the arrangement of the flow distributor 20 in the inner region 5 of the container 2 results in a deviation of the inflowing material, whereby in support, the container 8 is additionally designed such that the guiding surfaces 61 support the uniform distribution of the material in the container 2. Furthermore, with the depicted arrangement of the flow distributor 20, the advantage is achieved that the inflowing material is not mixed directly with the condensation stored in the collecting reservoir 24, so that the flow distributor 20 also has a protective function here.

With respect to inlet 4, it should be noted that this is provided with a plurality of means for thermal insulation with respect to the inner region 5, whereby these are arranged in partial area 9, which extends over the total outer area 6 of inlet 4, which is in contact with the inner area 5 of container 2. The inlet 4 is formed as a double-walled pipe, so that it comprises two jackets 10, which are arranged co-axial to each other. Between the two jackets 10 a thermally insulated layer 11 is present as vacuum, whereby the inner surfaces 12 of the jacket 10 are mirrored.

In order to prevent that in particular liquid components of the polymerizable material collect and/or remain adhered to the surfaces limiting the inner space 5, the whole outer surface 6 of the inlet 4, the whole jacket surface and/or tip 21 of the flow distributor 22 and also the inner wall of the container 2 are provided with the coating 22, which has an improved glide property for liquids compared to steel.

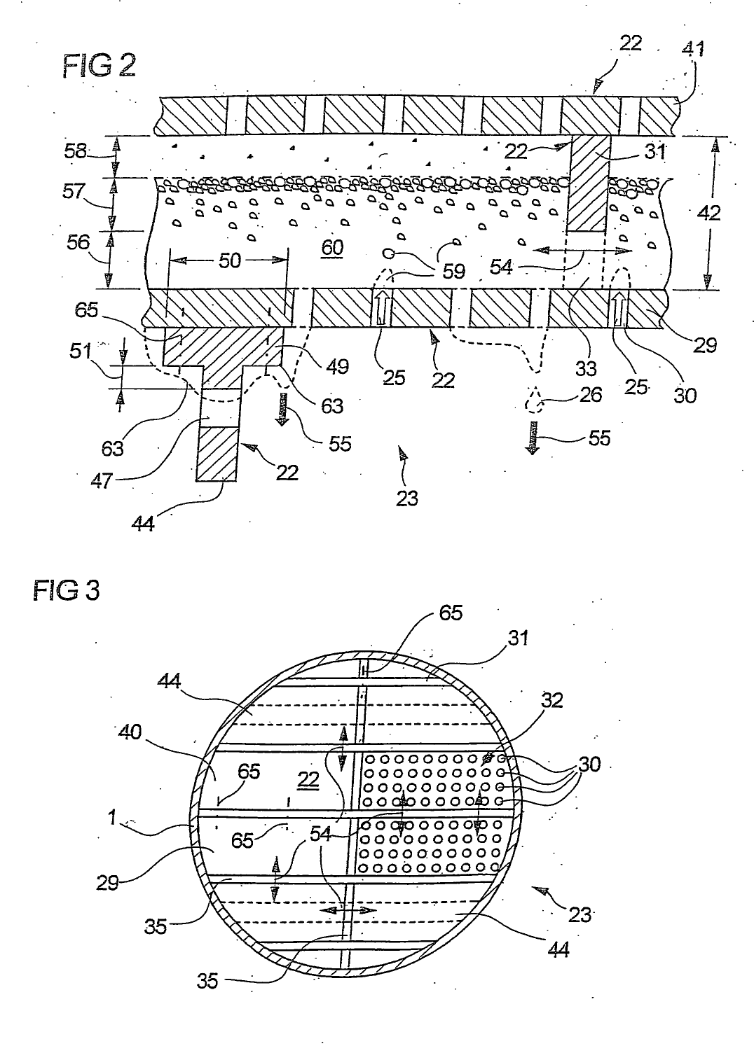

FIG. 2 shows schematically and in a partial section a separating tray 23, which comprises a cover plate 41, an attachment 31, a tray plate 29 and a carrier 44. The liquid 60 is arranged between the cover plate 41 and the tray plate 29. The gaseous, polymerizable material comes into contact in flow direction 25 with the liquid 60 through the opening 30 of the tray plate 29, whereby different border layers form between the tray plate 29 and the cover plate 41. In this way, a liquid layer 36 can be recognized, which is substantially free from bubbles 59. Above this, a vapor bubble layer 57 and/or a type of foam layer is arranged. This represents practically a type of border layer between the liquid 60 and the gaseous volume. Between the cover plate 41 and this vapor bubble layer 57, a droplet layer 58 is further arranged, whereby this is substantially characterized by a gaseous state of the material to be distilled, which is pervaded by liquid drops 26 coming from cover plate 41. While the gaseous material moves from below to above in flow direction 25 (as depicted in the picture) the liquid 60 follows gravity 55 and falls in the opposite direction (counter current flow principal) towards the lower floor 8 (not depicted).

It should further be mentioned at this point that the cover plate 41 is not necessarily constructed in one part but can also be in more than one part. In another aspect, the cover plate 41 comprises a plurality of structured plates and/or plastic elements, which are piled into packages and between which (in one aspect, not linear) flow passages form. The plates and/or plastic elements may be arranged substantially parallel to the direction of gravity, in particular at a distance 42 from the tray plate 29 in the range from about 100 to about 200 mm. The plates and/or plastic elements may be provided in such a way that a thickness of the cover plate 41 or of the package of about 100 to about 200 mm results.

The tray plate 29 comprises a plurality of openings 30, which are divided with assistance from the attachment 31 into more than one group 32 (see FIG. 3). The attachment 31 is, however, designed such that apertures 33 through which fluid and/or liquid 60 can flow and which ensure, in the direction of arrow 54 (i.e. substantially parallel to tray plate 29 and/or substantially perpendicular to flow direction 25 of the material), a liquid exchange from openings 30 arranged adjacent to each other. Attachment 31 is here provided with a coating 22, which has an improved glide property for liquids compared to steel. At the same time, the attachment 31 functions as separation limiter and/or supporting wall with respect to the two plates 29 and 41. In this way, it is ensured that the cover plate 41 is arranged at a pre-determined separation 42 from the tray plate 29, such as parallel to tray plate 29. Taking into account the size and/or height 34 of the apertures 33, it should be recognized that this is formed substantially somewhat smaller than the liquid layer 56, so that in upper-lying regions of the liquid layer 56 which are arranged near to the vapor bubble layer 57, the flow is hindered, while near to the tray plate 29 in the direction of the arrow 54 relatively unhindered liquid movements are enabled. The cover plate 41 can also be formed as flow rectifier 64, in particular as honeycomb structure 68 with a plurality of channels through which a fluid can flow.

On the side 45 facing away from attachment 31, a carrier 44 is provided as holder. The carrier 44 is formed T-shaped and comprises a foot 49 arranged substantially parallel to tray plate 29, with an imaginary dimension 50 as well as a lower carrier part which is substantially perpendicular hereto. Recesses 47 are provided in the carrier part of the T-shaped carrier 44 substantially perpendicular to the tray plate 29. In the embodiment example depicted, the recesses 47 are arranged at a separation 51 of less than about 3 mm. In this way, a plurality of tear edges 63 is formed which have the result that draining liquid (depicted as dashed line) forms drops 26 and comes away from the surface in the direction of gravity 55. In support of this effect, both the tray plate 29 and the carrier 44 are provided with a coating 22, which comprises in particular Teflon®.

FIG. 3 shows, schematically and in a top view, the further embodiment of a separating tray 23 according to the invention. As can be seen here, the depicted separating tray 23 spans the total inner area 5 of the column 1 or of the container 2. It is, however, also possible that a plurality of separating trays 23 of this type, such as square, are put together in a unified platform, which then spans the total inner area 5 of the column 1. The round embodiment shown here of the separating tray 23 comprises a plurality of openings 30, whereby these are divided by attachment 31 into several groups 32. The attachment 31 comprises a plurality of bars 35, which are connected in regular arrangement with each other by means of joining technology. The thus-designed attachment 31 forms sectors 40 of the tray plate 29 with respectively one group 32 of openings 30. The attachment 31 is designed such that, in the direction of the arrow 54, an exchange of liquid or fluid from neighbouring sectors 40 is still ensured. With dashed lines are shown in addition the carriers 44 on the lower side 45 of the tray plate 29 provided with a coating 22. These are here connected directly to column 1 and serve inter alia to increase the stability of tray plate 29.

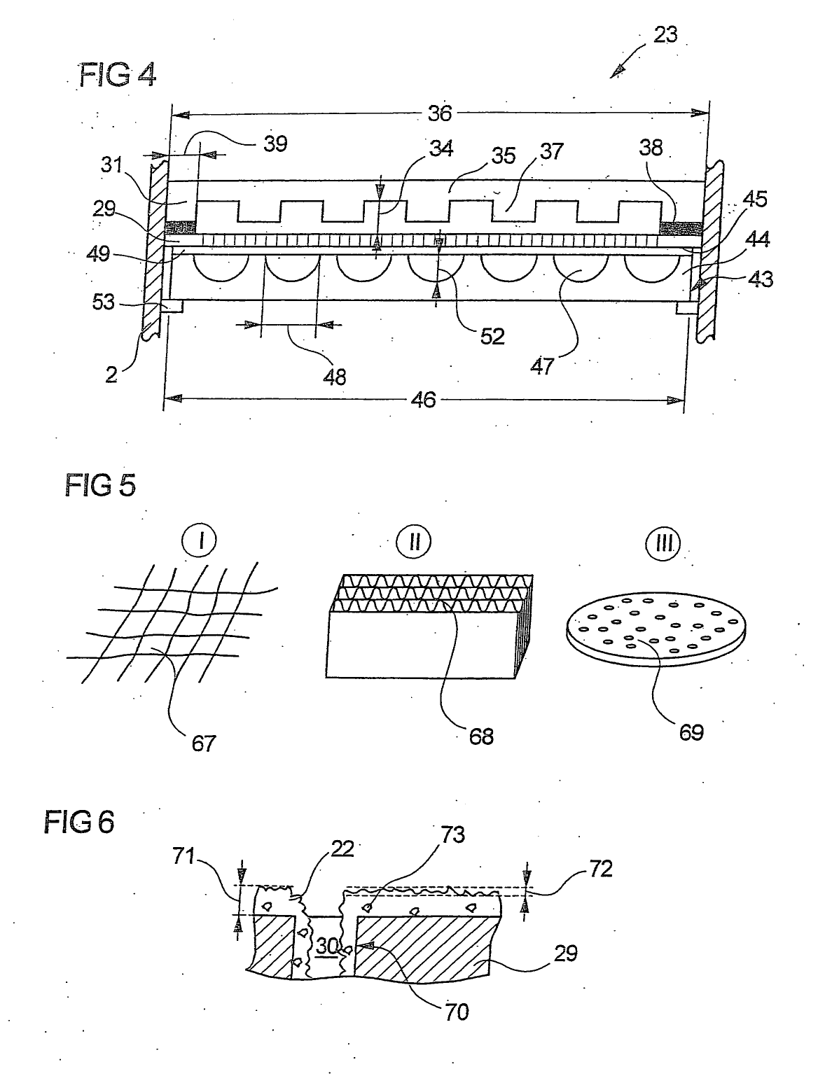

FIG. 4 shows a further section view for illustration of a variant of the separating tray 23 according to the invention. As can be seen from FIG. 4, the holder 43 of the separating tray 23 is provided with a carrier 44, which is connected by means of projections 53 to the container 2 of column 1, so that a substantially horizontal positioning of separating tray 23 in the inner region 5 of column 1 is ensured. The projections 53 are here shown simplified. In fact, a plurality of adjustment possibilities can be provided which enable an exact horizontal positioning of the separating tray 23 in the inner space 5. The carrier 44 shown has a dimension 46 and is T-shaped. Besides the carrier part positioned substantially perpendicular to tray plate 29, the carrier 44 comprises a foot 49 which serves as support plate for the tray plate 29. Directly at this foot 49 is attached, in the perpendicular carrier part, a plurality of recesses 47, whereby these are here formed as semi-circles. The semi-circular design 47 is not compulsory, but has advantages with respect to stiffness aspects because of its rounded contours. These recesses 47 can be described by an extension 48, which should be determined substantially parallel to tray plate 29 and/or to foot 49. Perpendicular hereto, the recesses 47 comprise respectively a width 52. The recesses 47 may be designed that the sum of the extensions 48 lies in the range from about 80% to about 30%, in another aspect from about 70% to about 40%, and in yet a further aspect from about 60% to about 65% of the dimension 46.

In FIG. 4, above the tray plate 29 is depicted an attachment 31 in the form of bar 35. The bar 35 is fixed by means of spacer 38 in the edge area of the tray plate 29 near to the container 2. By the simple provision of such spacer 38, a gap would already be generated between the bar 35 and the tray plate 29, which could already result in the here-described advantageous influencing of the fluid flow. In FIG. 4, for illustration, however, a further particular embodiment of the bar 35 with individual bars 37 is depicted. The bars 37 and/or the spacer 38 have a breadth 39, whereby the sum of the breadth 39 is considerably smaller than the length 36 of the bar 35 (for example less than about 50%). With respect to the above-mentioned percentages, it should be mentioned that in one aspect of the invention only the spacers 38 and/or bars 37 with their width 39 go in, which are in direct contact with tray plate 29, i.e. actually hinder the flow over the total fluid layer. With assistance from the bars 37 and/or the spacers 38, apertures 33 are accordingly formed, which, starting from the tray plate 29, may have a height 34 in a range from about 1 mm to about 100 mm, in another aspect from about 5 mm to about 50 mm, and in yet a further aspect from about 10 mm to about 30 mm.

FIG. 5 shows schematically different embodiments of flow rectifiers 64, which serve to improve the flow of the gaseous polymerizable material towards a separating tray 23. In principal, it should first be mentioned that such a flow rectifier 64 fulfils the function of achieving a uniform flow of the polymerizable material towards the at least one separating tray 23. Uniform in this sense means that, in one aspect, at least one of the factors flow speed and flow direction over the cross-section of the inner region of the column 1 near to separating tray 23 only has a deviation in the range of less than about 20%, in another aspect less than about 10%, and in yet a further aspect less than about 5%. This means, for example, that with a given flow speed of the vapor or gaseous state material of about 2 m/s to about 5 m/s [meter per second] at most deviations upstream of the flow rectifier of about 1 m/s [about 50% of about 2 m/s] to about 7.5 m/s [about 150% of about 5 m/s] are present. With respect to flow direction 25 is meant that starting from a flow impinging perpendicularly on the at least one separating tray 23 (perpendicular flow direction towards) a tolerance about this perpendicular flow direction towards of at most about 180°, in another aspect about 120°, in yet another aspect about 72°, in an additional aspect even only about 45°, and in yet an additional aspect at most about 20° is present. In respect of this, a symmetrical arrangement of the tolerances in respect of the perpendicular flow direction towards is assumed.

The flow rectifier 64 may be designed flat and positioned substantially parallel to the at least one separating tray 23 and/or fixed in the inner region 5 of column 1. The flow rectifier 64 may be at least partially made from a corrosion- and high temperature-resistant material and can be flowed through by a fluid. For this, in particular, openings are provided which, on the one hand, influence a flow profile, such as with respect to speed and/or direction, on the other hand, however, prevent a blocking or closing of the openings. The flow rectifier 54 may extend over the total inner region 5 of the column 1.

This flow rectifier 64 comprises accordingly at least one of the following elements: At least one grating structure 67, at least one honeycomb structure 68, at least one hole plate 69 or a so-called package. These elements can be connected directly or indirectly to the separating tray 23, in particular be a part of the separating tray 23. The grating structure 67 comprises more than one longitudinal, fiber-like structure, which are connected with each other chaotically or like a web. Suitable as such longitudinal, fiber-like structures are, for example, coated metal wires. The honeycomb structures 68 can be produced in one piece or from a plurality of components. The embodiment shown here comprises more than one smooth and structured plate layer which are connected to form a honeycomb structure 68. The hole plate 69 can, besides the depicted round embodiment, also be designed square, oval, with plural corners or in another way. In one aspect, the number of holes is more than about 30% of the total area of the hole plate 69.

FIG. 6 shows a detail of an embodiment of a separating tray 23 comprising a tray plate 29 with the coating 22 which has a reduced adhesive property for liquids compared to steel. It can be seen from the depiction that the coating 22 can be described by means of the parameters layer thickness 71, surface roughness 72 and porosity 73. The coating 22, which may comprise polytetrafluoroethylene is applied to contact surfaces 70, which would otherwise stand in direct contact with the polymerizable material. In this way, it is prevented that the material accumulates and polymerizes.

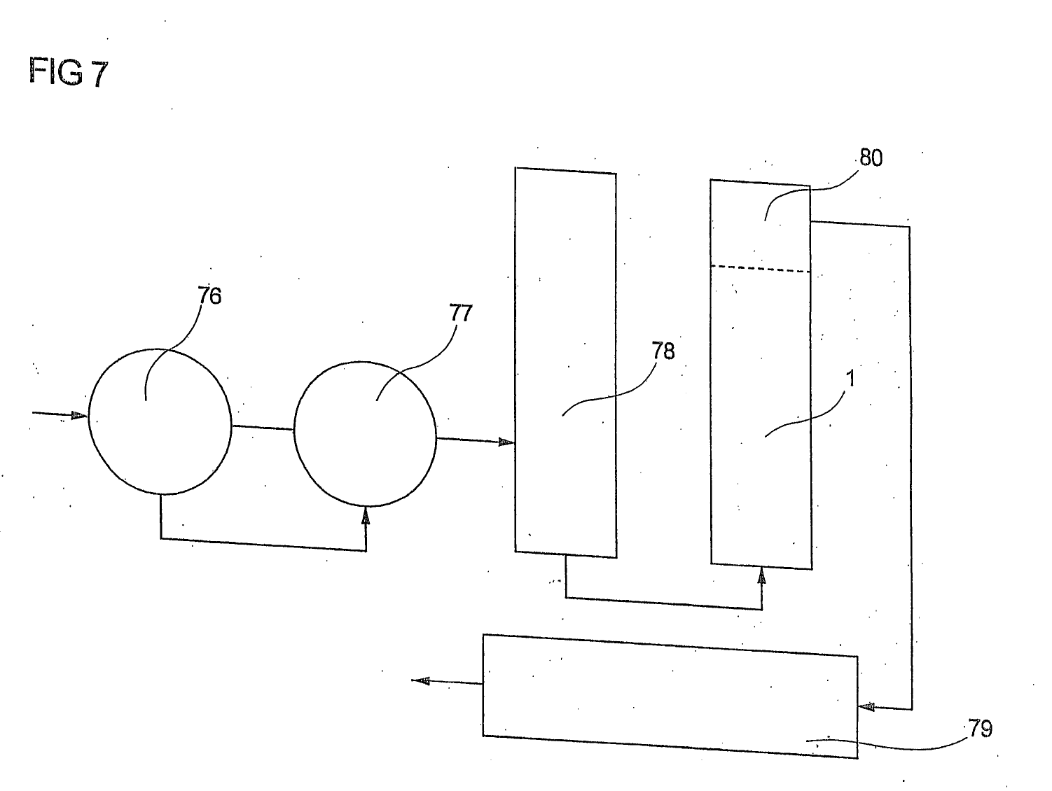

FIG. 7 shows schematically an installation for production of acrylic acid which comprises a first gas phase oxidation reactor 76 for oxidation of propylene to acrolein, which is connected to a further gas phase oxidation reactor 77, in which the acrolein is subjected to a further oxidation to acrylic acid. The acrylic acid gas mixture thus obtained in the further reactor 77 is fed to a quench device 78, to which is connected indirectly or directly a column 1 according to the invention. At the column according to the invention, one or more further purification units 79 can be connected. Among these can be, for example, crystallization devices such as layer crystallizers, suspension crystallizers which are connected to wash columns, or extractors or azeotropic distillers. The purification unit 79 is can be arranged at a part of column 1 at which the acrylic acid collects with the greatest purity, whereby it is the column head 80 in one aspect. By means of this design of device for production of acrylic acid, this is obtained in very high purity, mostly above about 99.8%. Comparable device designs are likewise conceivable for other polymerizable materials other than acrylic acid.

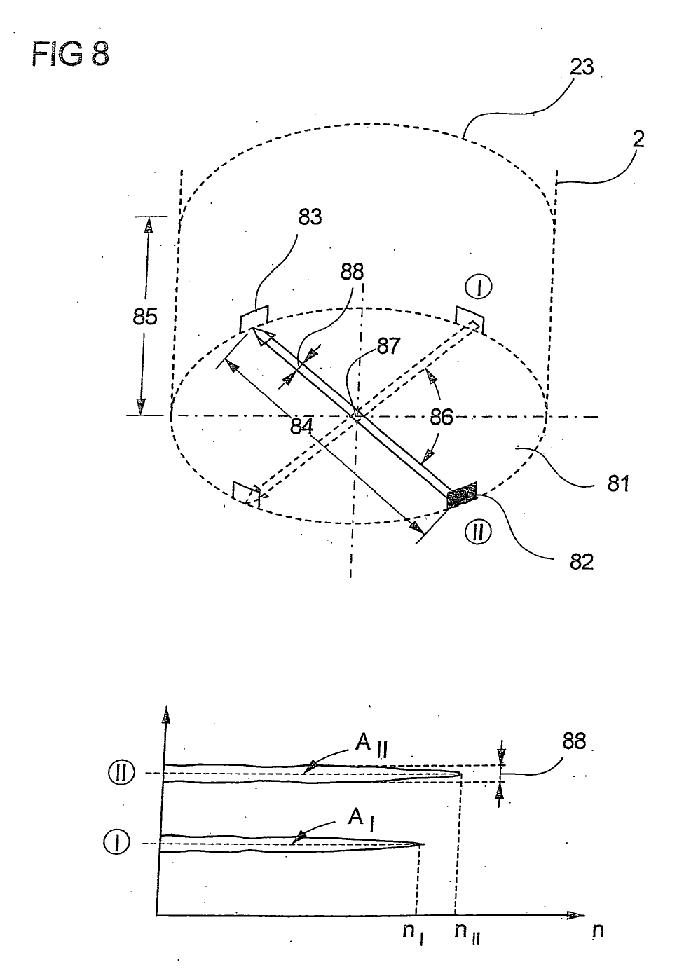

FIG. 8 shows schematically the construction of an experimental arrangement for determination of this density distribution of the vapor or gaseous state. Container 2 and first separating tray 23 are shown with dashed line. With a section 85, below the separating tray 23 an imaginary level 81 is depicted in which the determination of the isotropic density distribution in the vapor or gaseous state is carried out. The level 81 is, in the example depicted, free from other components of container 2 or components arranged therein. On opposite-lying regions of the level 81 are provided a source 82 for a radioactive radiation as well as a corresponding detector 83 for determination of the amount of impinging radioactive radiation. The source 82 sends a beam through the central point 87 of level 81 which substantially corresponds to the cross-section of container 2. Furthermore, a further position of the source and of the detector is depicted with a dashed line and identified with (II). The positions (I) and (II) are taken temporally one after the other and offset with respect to each other with a direction change 86, whereby respectively a measurement process has been carried out. In this process, the detector 83 has respectively counted the impinging impulse radiation.

The measurement result is shown schematically in FIG. 8 by means of two bar-type graphs. The measurement was carried out over a pre-determined time-period and with a certain beam width 88. The detector 83 has generated respectively a graph which shows the distribution of the count impulses (n) over the beam width 88. The maximum values of the first measurement (position I) and of the second measurement (position II) are indicated in the diagram with n_{I} and n_{II}. The integral of the count impulses (n) over the beam width 88 is indicated with A_{I} or A_{II} respectively. The value or the form respectively of the respective integral or of the value of the count impulse is characteristic for the density of the medium through which the beam has passed or for the vapor or gaseous state through which the beam has passed. A bar-type form of the integrals or a high value of the count impulse shows that a very large proportion of the radiation emitted from source 82 has reached detector 83. Conversely, a very low value of the count impulse or a sharp form of the graph indicates a denser medium through which at least part of the radioactive radiation did not pass.

If a measurement of this type is carried out at more than one position (I, II, . . . ) with a previously described device, in particular with an inventive device, a maximum deviation of the isotropic density within the level 81 between inlet 4 and the first separating tray 23 is at most about 15%. For the depicted embodiment example, this means that the value of n_{I} is at least about 70% of n_{II}. Because the number of detected impulses is characteristic for the density of the vapor or gaseous state through which the beam has passed, the parameter can be used as a measure for the density. Accordingly, in this way, it can be established that an isotropic density distribution according to the invention is present.

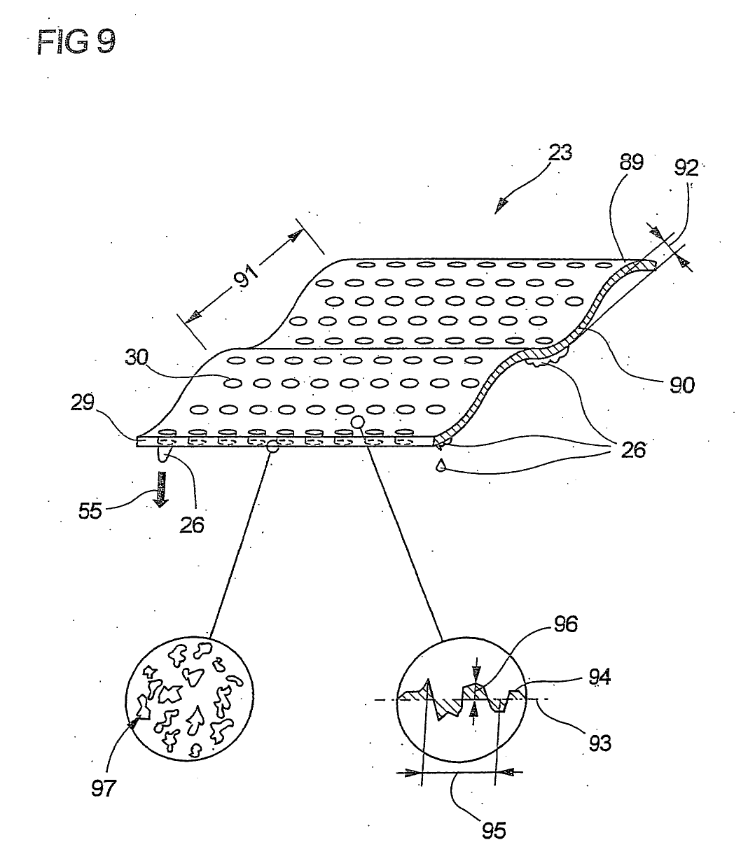

FIG. 9 shows schematically a detail of a particular form of an undulating or wave-form tray plate 29 of a separating tray 23. Such a tray plate 29, in particular with the following properties, has a plurality of holes 30 and is particularly advantageous, in combination with the here-described embodiment variants but also independent therefrom. The advantage of an undulating or wave-form tray plate 29 is that at the lower side the adhering liquid drops 26 run down to the wave troughs 90 and mingle locally with each other there. This further reduces the danger of polymerization. At the same time, this accumulation of liquid leads to this also finally detaching. With an undulating form of this tray plate 29, attachment 31, as, for example, shown in FIGS. 2 and 3, can be dispensed with, since the wave form itself provides a sort of separation, which hinders an undesired flowing back and forth of the liquid. In one aspect of the invention, more than one or even all separating trays 23 of a column 1 are equipped with such undulating or wave-form tray plates 29. In this aspect, tray plates 23 positioned adjacent to each other may be arranged offset to each other with respect to the positioning and/or orientation of the wave form, in particular in the form that the wave peaks 89 or wave troughs 90 respectively of tray plates 29 form an angle of about 90°.

In an additional aspect, the form of the tray plate 29 is with a wave height 92 in the range from about 0.5 to about 5.0 cm; such as in a range from about 1.2 to about 1.7 cm. With wave height 92, in this context, is meant the average vertical distance of a wave peak 89 and a wave trough 90 to each other. A wave peak 89 lies here at a horizontal separation from its adjacent wave trough 90 (corresponds to the wave length 91) of about 3.0 cm to about 10 cm, in particular the wave length 91 lies in a range from about 4.0 cm to about 6.0 cm.

A further improvement in respect of the reduction of the tendency to polymerize can be achieved by means of special forms of surfaces of column 1 which come into contact with the polymerizable material. This is particularly the case for at least a part of the separating tray 23, of the flow distributor 20, of the inlet 4, of the flow rectifier 64 or of the container 2.

According to a variant, at least one of the above-mentioned surfaces or its coating respectively is at least partially provided with a particularly low average roughness value (Rₐ). The average roughness value is the arithmetic average (over a reference path 95) of the absolute amounts of the distances 96 of the actual profile 94 from the central position 93. In this aspect, the average roughness value lies in a range less than about 2.0 μm (micrometer), such as in a range from about 0.5 μm to about 1.0 μm. With such an average roughness value, the tendency of the liquid to adhere relative to the surface wetted by it is reduced, so that this liquid runs away or drops away more quickly. In FIG. 9, such an average roughness value is depicted as an example and illustration with reference to the surface of the tray plate 29.

In addition, the possibility also exists (alternatively or cumulatively) to provide at least one of the above-mentioned areas at least partially with a so-called self-cleaning surface and/or coating. This self-cleaning surface may have an artificial, at least partially hydrophobic surface structure of raised parts and recesses, whereby the raised parts and recesses are formed by particles fixed on the surface by means of a carrier. This is advantageously distinguished in that the particles comprise a jagged structure with raised parts and/or recesses in the nanometer range (nanostructure 97 is shown schematically in FIG. 9). In one aspect, the raised parts comprise on average a height of about 20 to about 500 nm (nanometer), such as from about 50 to about 200 nm. The separation of the raised parts or recesses respectively on the particles amounts to less than about 500 nm in one aspect, and less than about 200 nm in another aspect. The jagged structure with raised parts and/or recesses in the nanometer range can be formed, e.g. by means of hollow spaces, pores, scores, peaks and/or spikes. The particles themselves have an average size of less than about 50 μm (micrometer), in another aspect less than about 30 μm, and in yet a further aspect less than about 20 μm. The particles may comprise a BET-surface area from about 50 to about 600 m²/g (square meter per gram). In another aspect, the particles comprise a BET-surface area from about 50 to about 200 m²/g. The so-called “BET-surface area” refers to the determination of this specific surface area by the well known process of BRUNAUER, EMMET and TELLER.

As structure-forming particles, diverse compounds from many branches of chemistry can be used. Inorganic particles may be used. In one aspect, the particles comprise at least one material selected from silicates, doped silicates, minerals, metal oxides, silicic acids, polymers and metal powders coated with silicic acid. In another aspect, the particles comprise pyrogenic silicic acid or precipitation silicic acids, in particular aerosils, Al₂O₃, SiO₂, TiO₂, ZrO₂, zinc powder jacketed with aerosol R974, such as with the particle size of about 1 μm (micrometer) or powdery polymers, such as, for example, cryogenic, milled or spray-dried polytetrafluoroethylene (PTFE) or per-fluorinated copolymers or respectively copolymers with tetrafluoroethylene. Particles of these types and coatings for generation of self-cleaning surfaces can be obtained, for example, from DEGUSSA AG.

Measurement Methods

The isotropic density (“direction-independent” density distribution) of the vapor or gaseous state and the deviation respectively are determined, for example, with a process of the company Ingenieurbüro Bulander & Esper GmbH in Zwingenberg, Germany. By means of a radioactive source, a directed beam (with a pre-determined width, e.g. 5 cm) is sent towards a detector. Source and detector are located on opposite sides of the column so that the beam extends substantially horizontally through the column. As source are used, for example, cobalt (Co 60) and caesium (Cs 137) with an activity of about 0.3 to about 3.7 GBq.

The beam emitted during the operation of the column is measured advantageously with a scintillation detector in the form of impulses per unit time and forwarded to an analysis or display device. In principal, a plurality of detectors and/or sources can also be provided, which are optionally arranged distributed around the circumference of the column. This latter arrangement has the advantage that for comparison measurements in different directions the same experimental construction can be retained and simply other sources and/or detectors come into use, so that measurement imprecisions as a result of incorrect mounting can be avoided.

Concerning the construction of the experimental arrangement, reference is further made to the details concerning FIG. 8.

While a radioactive beam of this type is emitted for a pre-determined time period through the vapor or gaseous state, a counter of the detector recognizes the impinging radiation and counts the impulses. The number of impulses per unit time is a measure of the density of the material located between source and detector. A high value characterizes a low density, since a large proportion of the emitted radiation has reached the detector. Accordingly, a low value of the counted impulses is characteristic for a higher density.

A uniform flow of the vapor or gaseous state can be recognized, for example, in that in a cross section the liquid and gaseous components are uniformly distributed. By this it can be recognized that the separating trays are locally blocked (so that, there, only a small proportion of liquid is present in the vapor or gaseous state and thus a lower density) or, for example, regions with reduced gas flows are present (where, because of the reduced counter-pressure, an increased liquid flow and thus an increased density can be observed).

To determine the isotropy, it is now proposed, first to undertake a measurement in a first direction in a level below the first operating tray and to acquire the detected radiation over a given time period (t; e.g. 5 min) (n). In order to reduce the influence of operational variations of the column, this measurement can also be carried out plural times, whereby a value (nᵢ) is recorded over the time period (t). An average value (N) is then formed and used as reference for the isotropy. It should here be further mentioned that the radioactive beam is emitted with a certain width (e.g. 5 cm) and the detector optionally has a resolution which enables a differentiation of the measured values over this width. Then, in turn, the average value or the area under the graphs (the integral) can be taken as reference, which represents the impulse rates over the width.

After a characteristic value or characteristic integral for the detected radiation has been recorded, the above-described procedure is repeated on the same level but in a direction deviating therefrom. The two directions enclose an angle which, in one aspect, is greater than about 30° and may be even greater than about 40°. In this way, at least two such measurements from different directions should be carried out, in particular even at least three.

In principal, a direction along the diameter of the column should be selected, in order to ensure that the free radiation length through the vapor or gaseous state is equally long and that accordingly the values for the detected radiation can be compared with each other. This is then possible because the radiation has passed through the same volume of the vapor or gaseous state. It is, naturally, also possible, to select a radiation path deviating herefrom, it should simply be ensured that this has the same length for each measurement.

The level can, in principal, be arranged in any way in the column and can be substantially parallel to at least one separating tray. In order to check the uniformity of the flow, such directional radiations through a separating tray, the distillate or through the vapor or gaseous state can be undertaken. In order to characterize the flowing towards behavior of the first separating tray, the level may be selected within a region less than about 200 mm below the first separating tray. In particular, the level lies in a region from about 100 mm to about 10 mm below the first separating tray.

An isotropy of the density is present in the meaning of the invention, in particular, then, if the deviation of the recorded measured values (n and/or N) is at most about 15%. For determination of the deviation, an arithmetic average (M) of the measured value is determined. It is defined for a given number of direction measurements (X) as quotient from the sum of the measured values per direction (n_{X} and/or N_{X}) and the number of measured values (X). With a maximum deviation of, for example, about 5%, it is meant that the highest measured value of the impulse rate and the lowest measured value lie in a range from about 0.95 M to about 1.05 M. With the deviation given here, the measurement deviation as the result of cosmic environmental radiation (around +/−50 count impulses for generally about 3 seconds measurement duration and a measurement band of about 50 mm) can be already taken into account.

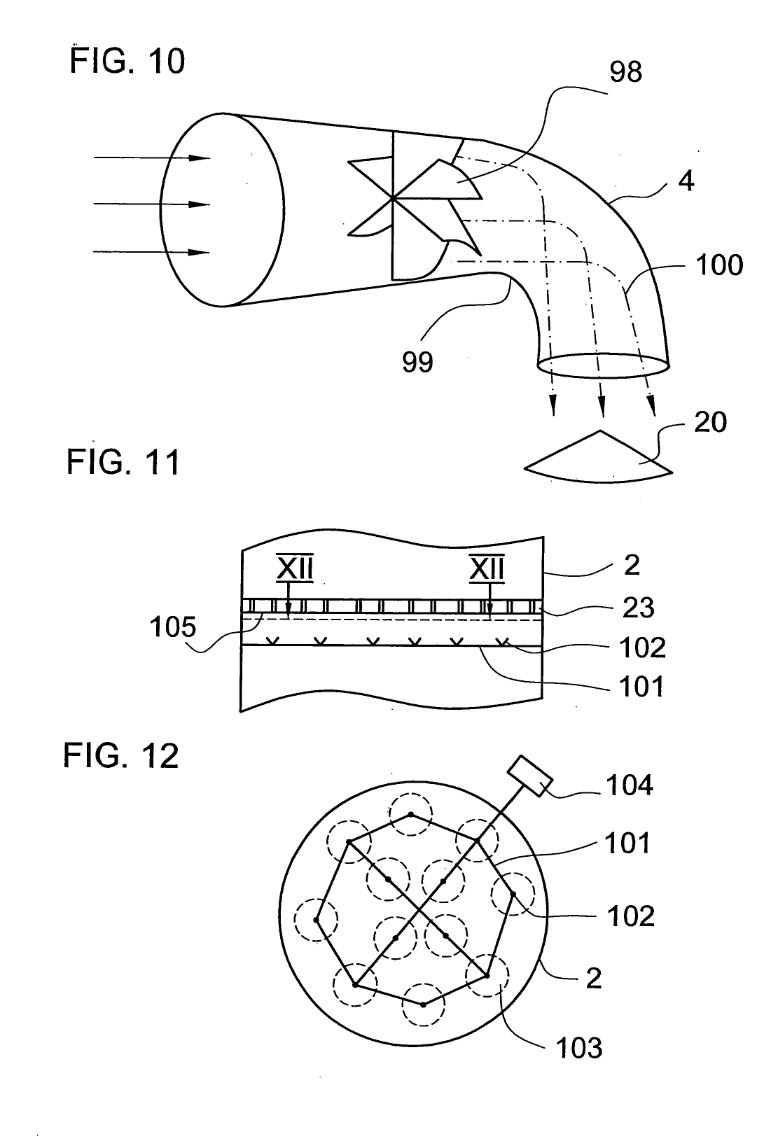

FIG. 10 shows, schematically and in perspective, a further embodiment of the inlet 4 with a flow mixer 98 as a particular form of a flow influencer. The depicted inlet 4 comprises a bend 99, in which the polymerizable material is deflected. If the polymerizable material would, without a flow influencer, flow freely through such an inlet 4, the bend 99 would cause a non-uniform speed distribution of the flow over the cross-section of the inlet 4. The reason for this is flow turbulence and backflows in the region of the bend 99. In order to prevent this, it is also possible to provide a flow mixer 98 upstream in the proximity (such as directly before) bend 99. Such a flow mixer 98 divides the polymerizable material flowing towards it into more than one filament 100 and deflects these such that they follow substantially the same path through the bend 99. The polymerizable material may be at least partially set in rotation. Thereby, a unified flow can be generated without pulsations and back-mixings, so that the cross-section of the inlet 4 is uniformly flowed across, also after bend 99, and the polymerizable material impinges, for example, on the flow distributor 20 uniformly distributed. It should further be mentioned that the provision of such a flow influencer and/or flow mixer 98 can occur at more than one bend 99 of inlet 4.

FIG. 11 illustrates a partial section of a container 2 with a spray unit 101 in cross-section, whereby in FIG. 12 a top view of the spray unit 101 shown in FIG. 11 is shown. Container 2 has a separating tray 23, whose lower side 105 (in particular during operation of the column 1) is cleaned with a spray unit 101. Such a spray unit 101 may be provided at least for the lowest separating tray 23 of container 2, if this comprises a plurality of separating trays 23 arranged one above the other. Through this separating tray 23 flows a liquid of the polymerizable material with a certain composition, which is then collected, for example, in a collecting reservoir 24 of container 2. Advantageously, it is now proposed to make this liquid available, via a supply device 104 of the spray unit 101 and thus to clean the lower side of separating tray 23. The use of this liquid has the advantages that no significant influence of the distillation in the lowest separating tray 23 takes place. With this spray unit 101, components of the polymerizable material (optionally already partially polymerized) adhering to the lower side 105 of the separating tray 23 are effectively removed.

The spray unit 101 itself can comprise a plurality of nozzles 102. These are designed such that a substantially uniform cleaning of the separating tray 23 over its entire cross-section can occur. In this case, the arrangement and/or the type of the nozzles can be accordingly selected. FIG. 12 shows schematically a possible embodiment of the spray unit 101 with uniformly distributed nozzle 102, which comprise a substantially uniform spray area 103. Such a design of the spray unit 101 is technically and economically simple, but not absolutely necessary. The nozzles 102 are arranged here such that the spray regions 103 substantially do not overlap, this is, however, also not compulsory. As nozzles 102, both simple openings in the spray unit 101 as well as separate nozzle components come into consideration.

### LIST OF REFERENCE NUMERALS

1 column
2 container
3 connection
4 inlet
5 inner region
6 outer area
7 partial section
8 lower floor
9 partial area
10 jacket
11 layer
12 inner area
13 entry orifice
14 exit orifice
15 flow influencer
16 baffle
17 channel
18 section
19 central axis
20 flow distributor
21 tip
22 coating
23 separating tray
24 collecting reservoir
25 flow direction
26 drop
27 heater
28 pump
29 tray plate
30 opening
31 attachment
32 group
33 aperture
34 height
35 bar
36 length
37 rod or bar
38 spacer
39 breadth
40 sector
41 cover plate
42 separation
43 holder
44 carrier
45 side
46 dimension
47 recess
48 extension
49 foot
50 dimension
51 distance
52 width
53 projection
54 arrow
55 gravity
56 liquid layer
57 vapor bubble layer
58 droplet layer
59 bubble
60 liquid
61 baffle
62 central axis
63 tear edge
64 flow rectifier
65 connecting element
66 jacket area
67 grating structure
68 honeycomb structure
69 hole plate
70 contact area
71 layer density
72 surface roughness
73 porosity
74 distance
75 liquid level
76 first gas phase oxidation reactor
77 further gas phase oxidation reactor
78 quench unit
79 purification unit
80 column head
81 level
82 source
83 detector
84 path
85 section
85 direction change
87 central point
88 beam width
89 wave peak
90 wave trough
91 wave length
92 wave height
93 central position
94 actual profile
95 reference path
96 distance
97 nanostructure
98 flow mixer
99 bend
100 flow filament
101 spray unit
102 nozzle
103 spray region
104 supply device
105 lower side

1. A column for distillation of a polymerizable material, the column comprising:
a container comprising a lower floor;
at least one inlet for the polymerizable material, which leads into an inner region of the column; and
a distributor for uniform distribution of the polymerizable material in the container.

2. The column according to claim 1, wherein the at least one inlet comprises an entry orifice and an exit orifice, wherein the exit orifice is arranged closer to the lower floor of the column than is the entry orifice and the exit orifice is arranged substantially parallel to the lower floor.

3. The column according to claim 1, wherein the at least one inlet comprises an exit orifice and at least one flow influencer.

4. The column according to claim 3, wherein the at least one flow influencer comprises at least one baffle forming a plurality of channels.

5. The column according to claim 4, wherein the at least one inlet comprises a bend and wherein the at least one flow influencer comprises a flow mixer provided upstream in proximity to the bend, wherein the at least one flow influencer is capable of dividing inflowing polymerizable material into more than one flow strand and diverting the flow strands so as to cover substantially the same path through the bend.

6. The column according to claim 1, wherein the at least one inlet comprises an exit orifice, wherein in the inner region of the column and a central axis the at least one flow distributor substantially coincide.

7. The column according to claim 6, wherein the at least one flow distributor is at least partially tapered, wherein a tip of the flow distributor is substantially aligned with a central axis of the exit orifice so that the tip of the flow distributor is closest to the exit orifice.

8. The column according to claim 1, wherein the container further comprises at least one guiding surface.

9. The column according to any claim 1, wherein the at least one inlet further comprises a thermal insulator capable of providing insulation from the inner region.

10. The column according to claim 9, wherein the thermal insulator is arranged at least partially on a portion of the inlet that extends into the inner region of the column.

11. The column according to claim 9, wherein the thermal insulator at least partially comprises a thermally insulating material.

12. The column according to claim 9, wherein the at least one inlet has more than one jacket, wherein a thermally insulating layer is provided between at least two jackets.

13. The column according to claim 12, wherein the thermally insulating layer comprises a vacuum.

14. The column according to claim 1, wherein at least a portion of the at least one inlet comprises an adhesive resistant coating.

15. The column according to claim 1, wherein the at least one inlet is arranged between the lower floor and a separating tray.

16. The column according to claim 1, wherein the container comprises a plurality of separating trays and a least one spray unit capable of providing the polymerizable material to a lower side of at least one separating tray.

17. A process for purification of a polymerizable material, process comprising:
introducing the polymerizable material as a liquid through an inlet into a container comprising a lower floor and an inner region; and
transferring the polymerizable material to a vapor in the inner region.

18. The process according to claim 17, wherein the gas flows with an isotropic density against a first separating tray arranged above the inlet, wherein within a level between the inlet and the first separating tray the maximum deviation about an average value of the isotropic density is at most about 15%.

19. The process according to claim 17, wherein the polymerizable material comprises (meth)acrylic acid.

20. The process according to claim 17, wherein a reduced pressure is present in the inner region.

21. The process according to claim 17, wherein the material liquid is superheated.

22. A process for production of a polymerizable material, the process comprising:
synthesizing the polymerizable material from at least one reagent in a reactor; and
introducing the polymerizable material as a liquid through an inlet into a container comprising a lower floor and an inner region; and
transferring the polymerizable material to a vapor in the inner region.

23. A use of an inlet according to claim 1 for distillation of a polymerizable material.

24. A polymerizable material obtainable by a process according to claim 22.

25. A use of a polymerizable material according to claim 24 as starting material in formed masses, fibers, sheets, absorbent polymers, in polymers for leather and textile processing, in polymers for water treatments or in polymers for soap production.

26. A product comprising any one of formed masses, fibers, sheets, absorbent polymers, polymers for leather and textile processing, polymers for water treatment or polymers for soap production, at least partially based on a polymerizable material according to claim 24.
